(19) United States
(12) Patent Application Publication
(10) Pub. No.: US 2026/0169546 A1
(43) Pub. Date: Jun. 18, 2026

(54) INVERSE TEMPERATURE DEPENDENCE VOLTAGE MARGINING

(71) Applicant: MICROSOFT TECHNOLOGY LICENSING, LLC, Redmond, WA (US)

(72) Inventors: Richard Gerard HOFMANN, Cary, NC (US); Serena BADRAN-LOUCA, Raleigh, NC (US); Jeremiah FRANKE, Tigard, OR (US); Larry Alan WOODRUM, Austin, TX (US)

(21) Appl. No.: 18/978,286

(22) Filed: Dec. 12, 2024

(51) Int. Cl. G06F 1/3296; G01K 3/14

(52) U.S. Cl. CPC G06F 1/3296; G01K 3/14

(57) ABSTRACT

A system for reducing power consumption in a computer processor core includes a plurality of hot and cold temperature sensors positioned within the processor core. A plurality of temperatures may be estimated from corresponding temperature sensors, and a plurality of voltage candidates may be determined from the estimated temperatures and a mapping of temperature to voltage margin, wherein the mapping includes both a direct temperature-to-voltage mapping for a first range of performance targets and an inverse temperature-to-voltage mapping for a second range of performance targets. A voltage supplied to the processor core may be controlled based on a maximum of the voltage candidates.

### BACKGROUND

The electrical voltage supplied to a computer processor is generally related to the clock speed supplied to the computer processor. The speed with which information propagates through individual circuits of a processor depends on electrical voltage supplied to the core, where individual logic gates will transition between “0” and “1” more quickly when the logic gates are supplied with a larger electrical potential. A computer processor with an increased clock speed will have shorter latency between ticks of the clock and hence require electrical signals to propagate more quickly through the logic gates in the processor. Electrical signals will propagate more quickly through logic gates when the logic gates are supplied with a larger voltage. Therefore, in order to increase a processor's clock speed, a related increase in supply voltage may be required in order for a logic circuit to reliably produce a correct output.

In pursuit of ever more electrical power efficiency, modern computer processors sometimes support a wide operational range of supply voltages and range of clock speeds. In response to changing computer performance requirements for a processor, clock speed and supply voltage may be dynamically adjusted to use less power when performance requirements are low. Processor performance generally scales linearly with changing clock speed, while power consumption is generally proportional to the square of the supply voltage and power consumption is generally linearly proportional to the clock speed. This combination can result in considerable power savings from proportionally smaller performance changes.

Large computer server systems, such as cloud computing farms, may include tens of thousands of computers, each computer with hundreds or thousands of processor cores that are used to simultaneously serve a wide variety of customers, and different customer's compute loads will generally have varying requirements for computing performance. Power efficiency of such large computer systems can be improved by dynamically tailoring clock and power supply to localized performance requirements. Thus, there remain ongoing needs for power efficiency improvements in computing systems.

### SUMMARY

Improved power efficiency of computer processors may be achieved by reducing the supply voltage required to produce reliably correct output at a given clock speed. The time required for an electrical signal to fully propagate through a logic gate can be dependent on the current operating temperature of the circuit. A temperature sensor embedded in or near a logic circuit can be used to dynamically determine a supply voltage necessary to produce a correct output at a current clock speed. Ultra-low voltage threshold (Vth) processor technology (ULVT), for example with an operational range from 0.4 to 0.9 supply voltage, provides a particular challenge in determining a lowest reliable supply voltage for a given clock speed. Depending on the processor manufacturing technology used, for some supply voltage ranges, the required voltage supply will be directly related to the operating temperature, where an increase in temperature requires an increase in supply voltage for a correct result at a particular clock speed. For other lower supply voltages, the required voltage supply will be inversely proportional to the operating temperature, where a decrease in temperature requires an increase in supply voltage for a correct result at a particular clock speed.

Improved systems for reduced power consumption of a computer processor core include a plurality of temperature sensors positioned at a corresponding plurality of locations within the processor core. A plurality of temperatures may be estimated, each estimated temperature based on a corresponding temperature sensor of the plurality of temperature sensors. A plurality of candidate voltages for the processor core may be determined, each candidate voltage based on a corresponding temperature of the plurality of temperatures and a mapping of temperature to voltage margin, wherein the mapping includes a direct temperature-to-voltage mapping for a first range of performance targets and an inverse temperature-to-voltage mapping for a second range of performance targets. A core voltage may be selected based on a maximum of the candidate voltages at a particular performance target, and a voltage generator may be controlled to provide the selected core voltage to the processor core.

In a variation of the improved techniques, a baseline voltage may be determined based on the performance target for the processor core, and core voltage may be selected based on a sum of the baseline voltage and a maximum of the candidate voltages.

In another variation of the improved techniques, at least one of the plurality of temperatures may be based on a high-temperature sensor positioned at a first location within the processor core and at least one of the plurality of temperatures is based on a low-temperature sensor positioned at a second location within the processor core, wherein the first location is proximate to circuitry with a higher power density than the second location.

Some variations of the improved techniques include three sensors. For example, the plurality of locations may include two hot locations determined likely to have two of the hottest temperatures (or likely to have a temperature higher than an average temperature) within the processor core and one cool location determined likely to have a lowest temperature (or likely to have a temperature lower than the average temperature) of the processor core. In another example, a first temperature of the plurality of temperatures is based on a first sensor positioned proximate to integer processing circuitry, a second temperature of the plurality of temperatures is based on a second sensor positioned proximate to floating point processing circuitry, and a third temperature sensor is based on a third sensor positioned proximate to cache circuitry.

Other variations of the improved techniques may further include determining a memory circuit control parameter based on the plurality of temperatures, the performance target, and the mapping, and then controlling a memory circuit inside the processor core based on the memory circuit control parameter.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 depicts an example system-on-a-chip (SoC) including temperature sensors.

FIG. 2 depicts an example voltage control engine.

FIGS. 3A-3C illustrate example applications of the voltage control engine of FIG. 2.

FIG. 4 depicts an example method for voltage selection.

FIG. 5 is a graph illustrating both direct and inverse temperature-to-voltage relationships.

FIG. 6 depicts a block diagram of a computing-based device that may be included in an example of any of the above systems.

### DETAILED DESCRIPTION

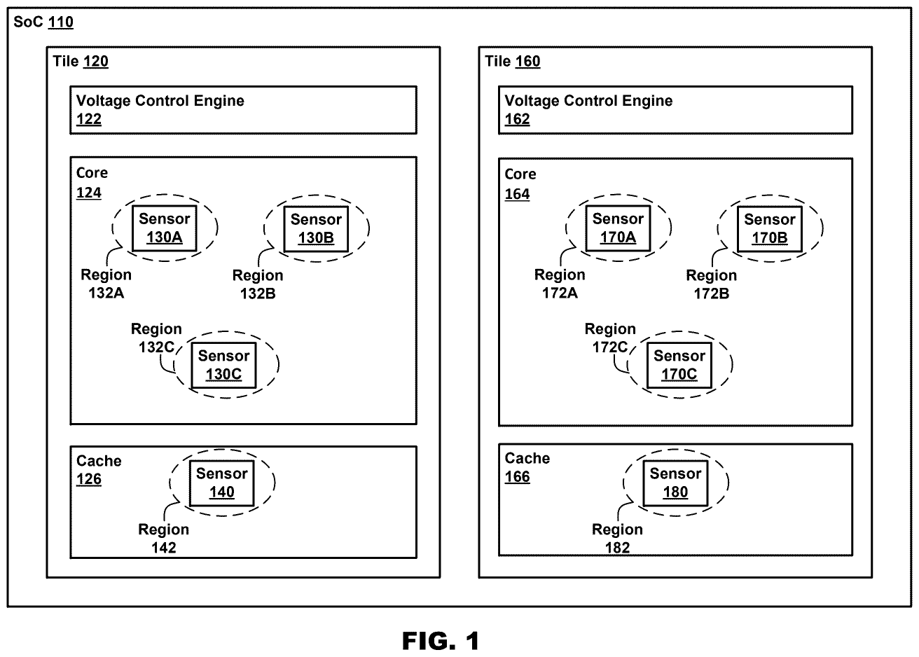

FIG. 1 depicts an example system on a chip (SoC) 110 including temperature sensors. SoC 110 includes two tiles 120, 160, each tile having a corresponding core 124, 164 for processing software and a corresponding voltage control engine 122, 162 and cache 126, 166 supporting the corresponding core 124, 164 within each tile 120, 160. Each tile 120, 160 includes 4 temperature sensors, each sensor positioned within a corresponding region. Core 124 includes sensors 130A-130C, each positioned within its corresponding region 132A-132C. Cache 126 includes temperature sensor 140 positioned within region 142. Similarly, core 164 includes temperature sensors 170A-170C positioned within regions 172A-172C, and cache 166 includes temperature sensor 180 within region 182.

SoC 110 may be, for example, a processor for a cloud computer. In other embodiments, a SoC for a cloud computer may include different numbers of tiles within a SoC, different numbers of cores with any tile, and different numbers of sensors with any core. In one example (not depicted), a tile in a SoC may include a single voltage control engine and two cores, where the single voltage control engine separately controls the supply voltages for two cores in the tile based on sensors in each cores. Similarly, a tile may include any number of caches outside the core (such as L3 caches), which may have a fixed supply voltage or may have a supply voltage that is determined by the voltage control engine separately from the supply voltage of the cores in the tile. A single SoC may include, for example, hundreds or thousands of cores.

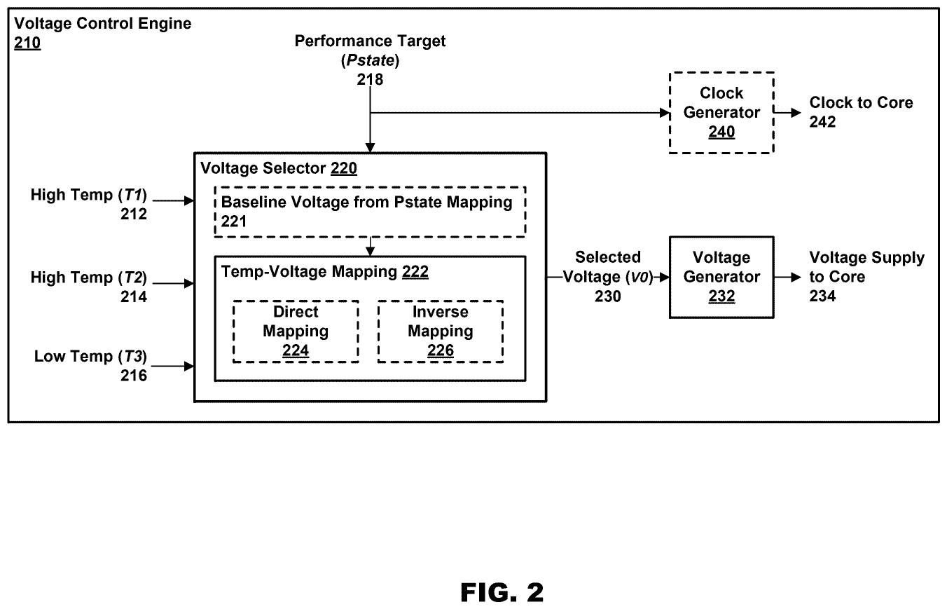

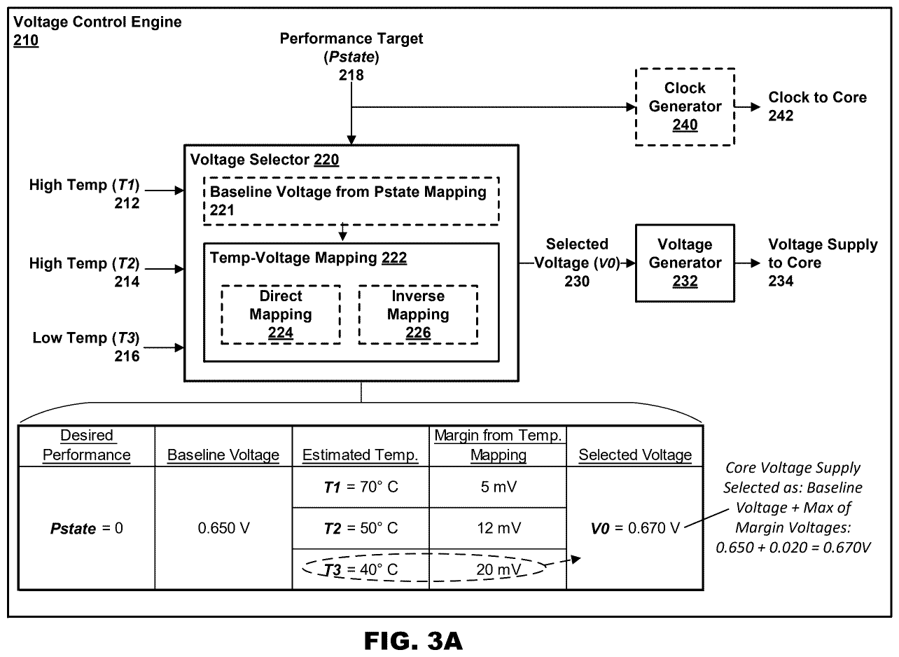

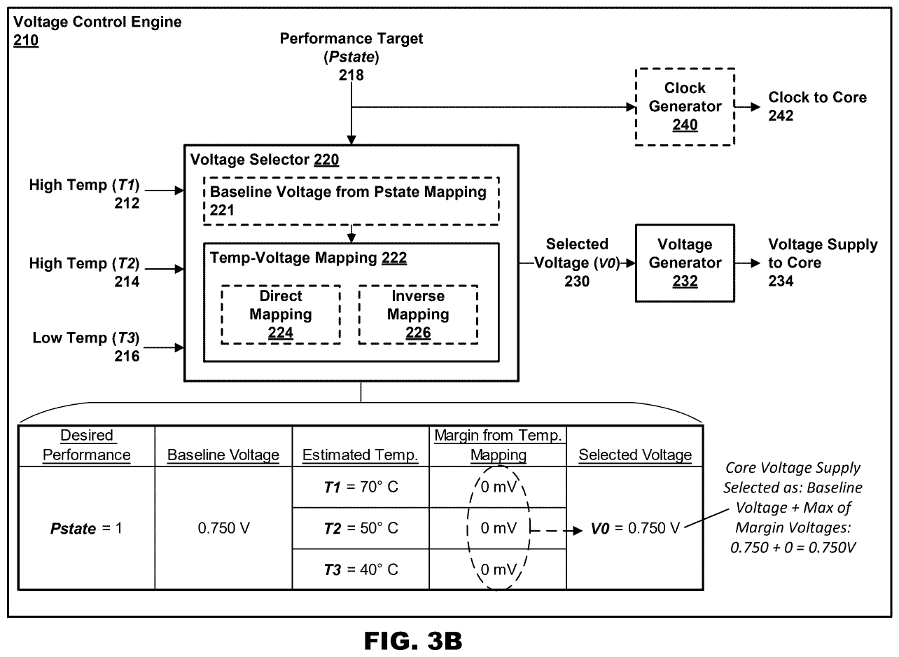

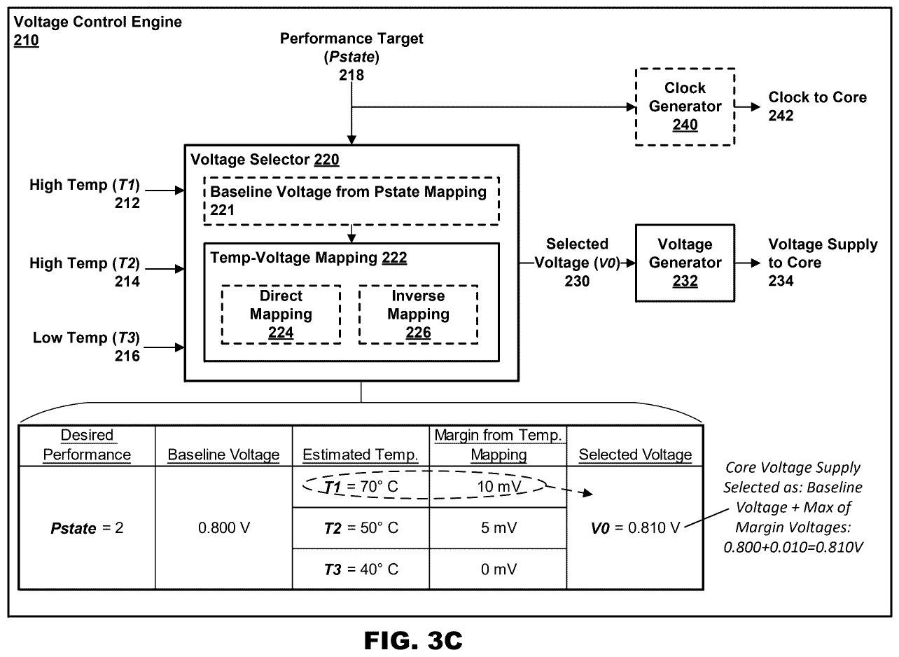

Voltage control engines 122, 162 may control a voltage level supplied to the core 124, 164 within its corresponding tile 120, 160. The voltage control engines 122, 162 may select a voltage based on data from the temperature sensors within its tile 120, 160, as further explained below with regards to FIGS. 2, 3A-C, and 4. In an aspect, a voltage control engine 122, 162 may operate assuming a fixed system clock speed or a fixed performance target for its corresponding core processor. In another aspect, voltage control engines 122, 162 may work in conjunction with an adjustable clock generator. For example, a voltage control engine may be part of a dynamic voltage and frequency scaling (DVFS) engine, wherein a DVFS engine includes an adjustable clock generator along with an adjustable voltage generator.

Temperature sensor placement locations within a core may include at least one location expected to be at or near the location predicted to have the highest temperature within the core, and at least one location to be at or near the location predicted to have the lowest temperature. Various techniques might be used to predict the locations of highest and lowest operational temperature. In one example, circuit power density or circuit density may be used to predict relative localized operational temperatures for the purposes of locating temperature sensors. For example, regions 132A and 132B may have the highest power density of circuitry within core 124, while region 132C may have the least power dense circuitry.

In another example, hot and cold locations within a processor core may be determined by the functional purpose of different regions. The functional purposes of different regions may be known to have different relative operational temperatures, and hence a temperature sensor may be located at or near certain functional blocks within the core. For example, integer and floating-point math computational units may be known as hot locations within a core, while memory caches may be known as cool locations. In this example, region 132A may be near integer math processing and therefore may be assumed to be a hot location, region 132B may be near floating-point math location and therefore may be assumed to be a second hot location, while region 132C may be near an L2 cache and therefore may be assumed to be a cold location.

Other methods for choosing hot and cold placement locations for the temperature sensors include design-time temperature simulation prior to manufacturing a core or using experimental test data of actual temperature measurements across various locations within a core using a separate temperature measurement tool prior to placing the sensors.

In an aspect, caches 126, 166 may be a level 3 (L3) cache supporting the core 124, 164 within its corresponding tile 120, 160. A level 2 (L2) cache may be located within the cores 124, 164, for example at or near a placement region for one of the sensors. For example, regions 132C, 172C may be at or near an L2 cache within core 124, 164.

FIG. 2 depicts an example voltage control engine 210. Voltage control engine 210 may be an example implementation of voltage control engines 122 and 162 (FIG. 1). Voltage control engine 210 includes a voltage selector 220 with a temperature-to-voltage mapping 222, and a controllable voltage generator 232.

In some optional aspects, voltage control engine 210 may work in conjunction with an optional controllable clock generator 240. Voltage selector 220 may include an optional baseline voltage from Pstate mapping 221, and temperature-to-voltage mapping 222 may include a direct temperature-to-voltage mapping 224 and a distinct inverse temperature-to-voltage mapping 226.

In operation, voltage control engine 210 receives three temperature estimates including two high temperature estimates 212, 214, and one low temperature estimate 216. Voltage control engine 210 also receives an indication of a desired performance target 218 for a processor core (referred to herein as a Pstate). Core performance, measured for example as a number of operations completed per second, is generally proportional to the speed of a clock driving the core. A processor core in a higher performance state (using a faster clock) generally executes software instructions more quickly than a processor core in a lower performance state (using a slower clock). Accordingly, optional clock generator 240 may generate a faster or slower clock 242 for the processor core based on the desired performance target 218.

Voltage selector 220 may select a voltage 230 for the core based on received temperatures 212, 214, 216 and desired performance target 218 for the core. A candidate voltage may be determined for each temperature 212, 214, 216 input using the temperature-to-voltage mapping 222, and the maximum voltage may be chosen to be output as the selected voltage (V0) 230 to voltage generator 232. Voltage generator 232 may then supply the selected voltage to a core processor 234. In general, a processor core will produce correct outputs when supplied with a higher core voltage than is required for any estimated temperature. Hence, choosing the maximum of the candidate voltages corresponding to each input temperature will ensure correct circuit outputs across all regions within a processor core.

For devices that support an operational range of supply voltage that include both direct and inverse temperature-to-voltage mappings, in some operational circumstances, the low temperature T3 will require the highest voltage for reliable correct core output (see FIG. 3A for an example). In other cases, a high temperature will require the highest voltage for reliable correct core output (see FIG. 3C for an example).

For some supply voltage operational ranges, such as for higher voltages, the entire operational voltage range for a particular device may have a direct temperature-to-voltage mapping, and hence the “direct” temperature-to-voltage mapping is sometimes referred to as the “normal” temperature-to-voltage mapping.

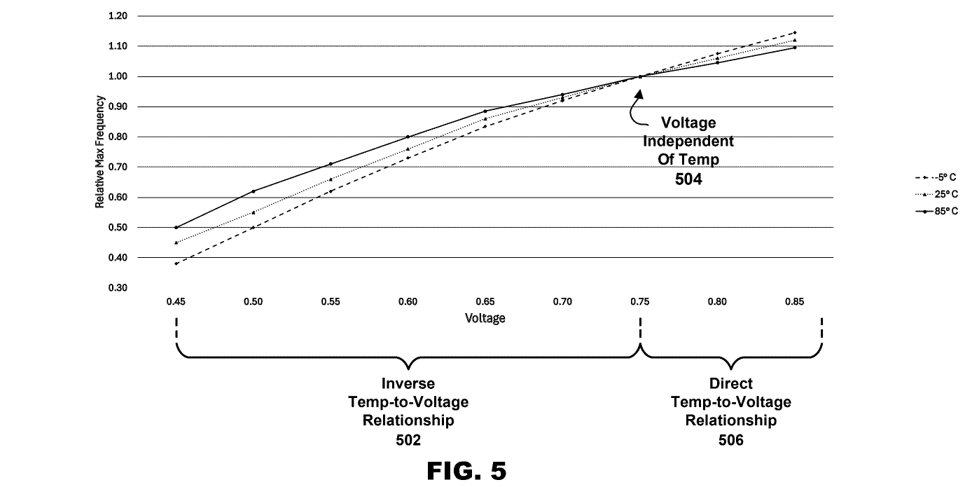

Direct and inverse mappings 224 and 226 may be used in different ways. In one aspect, the temperature-to-voltage mapping 222 may map input temperatures using a direct temperature-to-voltage mapping 224 for a range of higher core performance targets while using an inverse temperature-to-voltage mapping 226 for other lower core performance targets. A direct mapping produces a higher voltage in response to higher input temperature, while an inverse mapping produces a lower voltage in response to a higher input temperature. In some implementations there may also be a middle range of core performance targets (between the higher and lower ranges) where the mapping 222 produces voltages that are independent of temperature input. Direct and inverse temp-to-voltage mappings are discussed further below regarding FIG. 5. In a variation, a baseline voltage may be determined from the core performance target, and the direct 224 or inverse 226 mappings may be used based on the baseline voltage. In another aspect, direct mapping 224 may be used to determine voltages from high temperatures 212, 214 while inverse mapping may be used to determine a voltage from low temperature 216.

In some aspects, temperature-to-voltage mapping 222 may directly produce a core voltage (for each corresponding input temperature). In other aspects, temperature-to-voltage mapping 222 may instead produce a safety margin voltage (for each corresponding input temperature), which may then be added to a baseline core supply voltage to determine a core voltage. In these aspects, a baseline core supply voltage may be determined from the desired performance state using the baseline voltage from Pstate mapping 221. Alternately, a baseline core supply voltage may be determined from a core clock speed.

In some implementations, temperature-to-voltage mapping 222 may be implemented as a lookup table. In an example lookup table implementation, potential input temperatures may be grouped into bands of a few discrete temperature ranges. For example, input temperatures can be grouped into three bands including below 40° C., 40 to 60° C., and above 60° C. The temperature-to-voltage mapping 222 may then be implemented as a table of voltages indexed by a first index indicating a desired performance state (e.g. the Pstate), and a second index indicating a band of input temperatures. This pair of indices (Pstate, temperature range) may identify a single entry with the output voltage (e.g., either a core voltage or a voltage margin to be added to a baseline voltage).

Implementations of temperature-to-voltage mapping 222 may include a mapping of discrete points with interpolation between the discrete points. For example, a mapping to a core voltage or marginal voltage may be implemented as a table storing a list of discrete temperatures and corresponding discrete voltages. Given an input temperature estimate that falls between the two nearest discrete temperatures in the table, temperature-to-voltage mapping 222 may interpolate an output voltage based on two discrete voltages in the table corresponding to the two nearest discrete temperatures. For example, temperature-to-voltage mapping 222 may determine a selected voltage 230 based on a linear interpolation between the two voltages in the table. Direct mapping 224 and/or inverse mapping 226 may similarly include interpolation between discrete table entries.

In some embodiments, the temperature-to-voltage mapping may be adjustable, for example by changing the entries of a mapping table. Some manufacturing processes may allow for testing a SoC device during manufacturing to determine a mapping. In some aspects, individual parts may be evaluated at different voltages, performance states, temperatures, etc. to determine a temperature-to-voltage mapping for that individual SoC device which may then be stored, for example, as a mapping table such as temperature-to-voltage mapping 222. In other aspects, SoC devices may be classified into groups of parts rated, for example, to run with different maximum clock speeds, and then each group or class may be programmed with a different temperature-to-voltage mapping, such as by populating a memory storing the mapping table.

FIG. 3A illustrates an example application of the voltage control engine 210 for a slower desired performance target 218 (Pstate=0). A slower performance target may be implemented with a slower clock driving a processor core along with a lower baseline voltage of 0.650 V to support the slower clock. The baseline voltage may be determined, for example from the optional baseline voltage from Pstate mapping 221. Two high temperatures are input as T1=70° C. and T2=50° C., and a low temperature of T3=40° C. In the example of FIG. 3A, an inverse mapping is used to determine margin voltage from each input temperature. Because an inverse mapping is used, the coldest input temperature requires the highest margin voltage of 20 mV. The selected voltage is chosen as V0 =the baseline voltage+the maximum of the margin temperatures. In this example, the coldest temperature T3=40° C. produced the highest margin temperature of 20 mV, so V0 is determined to be 0.650 V baseline voltage+0.020 maximum margin voltage=0.670 V.

FIG. 3B illustrates an example application of the voltage control engine 210 for a middle desired performance target (Pstate=1). A middle performance target may be implemented with a middle clock speed driving a processor core along with a middle baseline voltage of 0.750 V to support the middle performance target. The same temperatures are input as in the example above with high temperature T1=70° C. and T2=50° C. and a low temperature of T3=40° C. In this example of FIG. 3B, the baseline voltage of 0.750 V corresponds to a range of core voltages between direct and inverse temperature dependence where margin voltage does not vary with temperature, and hence Temp to voltage mapping 222 may produce a zero margin voltage for any input temperatures in this middle core voltage range. The core voltage where required voltage margin does not vary with temperature is sometimes referred to as the Zero Temperature Coefficient (ZTC). The ZTC is a core supply voltage (or range of core supply voltages) between the inverse temperature-to-voltage range and the direct temperature-to-voltage range. A typical ZTC for ULVT processor devices is 0.750 V for some manufacturing technologies. In this example with a baseline voltage of 0.750 V, no voltage margin is required independent of any temperature measurements. The selected voltage for driving the core is therefore chosen as V0=the baseline voltage+zero margin voltage=0.750 V.

FIG. 3C illustrates an example application of the voltage control engine 210 for a higher desired performance target (Pstate=3). A higher performance target may be implemented with a faster clock driving a processor core along with a higher baseline voltage of 0.800 V to support the higher clock. The baseline voltage may be determined, for example from the optional baseline voltage from Pstate mapping 221. The same temperatures as in the prior example are used with two high temperatures input as T1=70° C. and T2=50° C., and a low temperature of T3=40° C. In the example of FIG. 3C, a direct mapping is used to determine margin voltage from each input temperature. Because a direct mapping is used, the highest input temperature T1 requires the highest margin voltage of 10 mV. The selected voltage for driving the core is chosen as V 0 =the baseline voltage+the maximum of the margin temperatures. In this example, the hottest temperature T1=70° C. produced the highest margin temperature of 10 mV, so V0 is determined to be 0.800 V baseline voltage+0.010 maximum margin voltage=0.810 V.

The Pstates described here for explanatory purposes only. Some embodiments may enumerate processor performance targets differently. For example, a lower Pstate number (e.g., Pstate=0), may represent a higher (faster) performance target, while a higher Pstate number (e.g. Pstate=15) may represent a lower (slower) performance target.

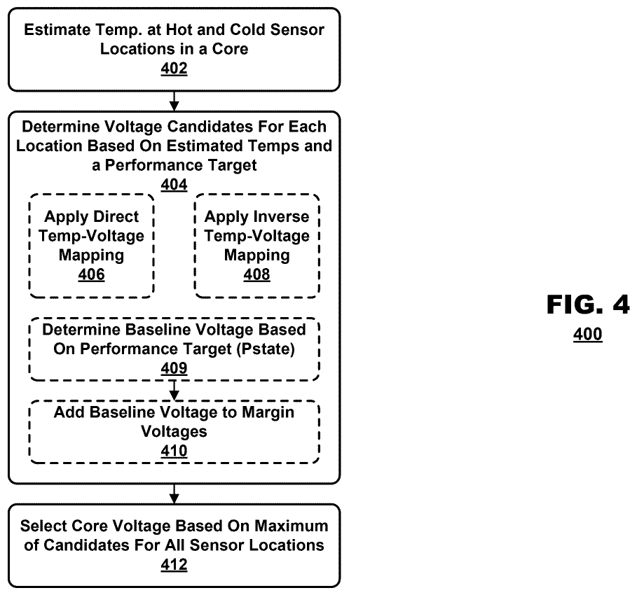

FIG. 4 depicts an example method 400 for voltage selection for a processor core. In some embodiments voltage selector 220 (FIG. 2) may be configured to perform the method 400. Method 400 includes estimating temperatures at hot and cold sensor locations within a processor core (block 402). The hot and cold sensor locations may have been selected as likely hottest and likely coldest locations within the processor core while executing a typical mix of processor instructions. Voltages candidates are determined for each sensor location based on its corresponding estimated temperature (block 404). Finally, a voltage is selected for the processor core based on the maximum of the candidate voltages for all sensor locations (box 412).

In some aspects, estimating temperatures (box 402) for a processor core may also include estimating a temperature for any temperature sensors located near or neighboring a processor core in addition to temperature sensors located within a core. In this aspect, with reference to FIG. 1, selection of a supply voltage for core 124 of tile 120 may include estimating temperatures from temperature sensors within tile 120 but outside core 124, or from sensors in the neighboring tile 160.

In other aspects, estimating a temperature from a sensor may include adding an offset to a temperature measured by the sensor, where the offset is based on the location of the sensor. In some manufacturing processes, it may be challenging or impossible to locate a sensor exactly where desired. For example, a center of a floating-point math unit is expected to be a hot location, but a sensor is instead located immediately neighboring the floating-point unit, an estimate of the temperature at the center of the unit may be made as a function of the temperature sensor neighboring the unit. In this example, it may be estimated that adding a constant 5 degrees to the temperature measured by a neighboring sensor is a good estimate for the location at the center of the unit.

Determining a voltage for each location (block 404) may include applying both a direct temperature-to-voltage mapping (block 406) and an inverse temperature-to-voltage mapping (block 408) to the estimated temperatures. In some aspects, a single temperature-to-voltage mapping, for example implemented as a look up table, may include both direct and inverse temperature-to-voltage mappings. In other aspects, the direct and inverse mappings may be implemented and applied separately, where for example, the inverse mapping is applied when operating the core in a lower desired performance target (Pstate) or with a slower clock, and the direct mapping may be applied when operating the core in a higher desired performance target or with a faster clock.

In an optional aspect, the voltages determined in block 404 may be marginal voltages instead of proposed supply voltages for the core. In this aspect, determined marginal voltages may be added to a baseline voltage determined from a desired performance target. In this aspect, a baseline voltage may be determined from the core performance target (block 409), and then the baseline voltage may be added to a voltage margin.

FIG. 5 is a graph 500 illustrating both direct and inverse temperature-to-voltage relationships. Graph 500 depicts example experimental results for measured maximum frequency possible of a ring oscillator in a ULVT device at various supply voltages and operating temperatures. In graph 500 the vertical axis indicates maximum frequency as a relative ratio of frequency from Zero Temperature Coefficient (ZTC) point. In this example experimental result, there are three different lines plotted for different operating temperatures (−5, 25, and 85° C.). These lines cross at a supply voltage around 0.75 V, indicating that the speed of the circuit (the maximum possible frequency) is independent of operating temperature in this supply voltage region 504. This region 504 includes the ZTC point at 0.75V, which may be typical for some modern manufacturing processes. Above this ZTC point, there is a direct relationship between supply voltage and operating temperature in the voltage range 506. Within the direct range 506, as operating temperature increases, a higher supply voltage is required to maintain a constant circuit speed. Below the ZTC point, there is an inverse relationship between supply voltage and operating temperature in the voltage range 502. Within the inverse range 502, as operating temperature decreases, a higher supply voltage is required to maintain a constant circuit speed.

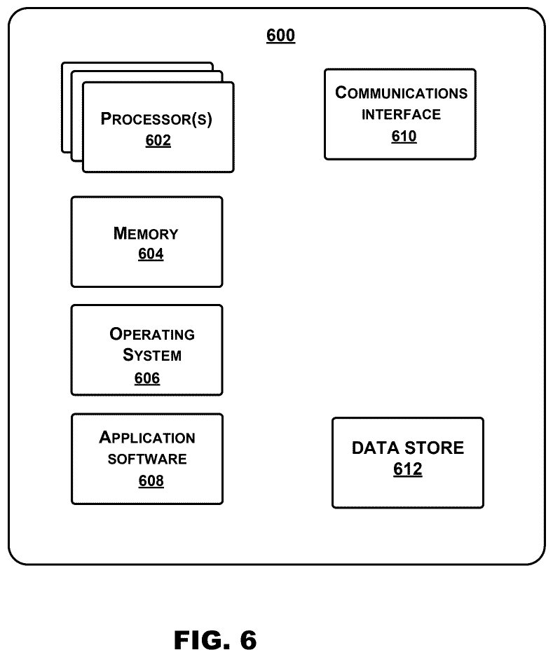

FIG. 6 illustrates various components of an example computing-based device 600 which are implemented as any form of a computing and/or electronic device. In some examples, computing-based device 600 is a general-purpose computer that is activated or reconfigured by a computer program stored in the computer. In other examples computing-based device 600 is specially constructed for the intended purpose. In some examples, computing device 600 is a microprocessor used in embedded systems applications or other suitable applications. Processor(s) 602 may be employed as examples of voltage control engines 122 and 162 (FIGS. 1, 2, and 3A-3C), and device 600 may be used to implement the method 400 (FIG. 4).

Computing-based device 600 comprises one or more processors 602 which are microprocessors, controllers or any other suitable type of processors for processing computer executable instructions to control the operation of the device. The processors 602 may include at least one general-purpose processing device such as a central processing unit, microprocessor, complex instruction set computing (CISC) microprocessor, reduced instruction set computing (RISC) microprocessor, or other general-purpose processing device. In some examples, for example where a system on a chip architecture is used, the processors 602 include one or more special-purpose processing device such as a fixed function block. The special-purpose processing device may be configured to execute instructions for performing the operations and methods described herein. Platform software comprising an operating system 606 or any other suitable platform software is provided at the computing-based device to enable application software 608 to be executed on the device. Data store 612 holds system prompts, context, bot code and other data.

The computer executable instructions are provided using any computer-readable media that is accessible by computing-based device 600. Computer-readable media includes, for example, computer storage media such as memory 604 and communications media. Computer storage media, such as memory 604, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device.

In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 604) is shown within the computing-based device 600 it will be appreciated that the storage is, in some examples, distributed or located remotely and accessed via a network or other communication link (e.g. using communication interface 610). The computing-based device is able to communicate with other bots and communications network nodes via communications interface 610.

The disclosure presented herein also encompasses the subject matter set forth in the following clauses:

### Clause 1

A method for reducing power consumption of a processor core including a plurality of temperature sensors positioned at a corresponding plurality of locations within the processor core, comprising:
estimating a plurality of temperatures, each temperature based on a corresponding temperature sensor of the plurality of temperature sensors;
determining a plurality of voltage candidates, each voltage candidate based on a corresponding temperature of the plurality of temperatures, a performance target for the processor core, and a mapping of temperature to voltage margin, wherein the mapping includes a direct temperature-to-voltage mapping for a first range of performance targets and an inverse temperature-to-voltage mapping for a second range of performance targets;
selecting a core voltage based on a maximum of the voltage candidates; and
controlling a voltage supplied to the processor core based on the selected core voltage.

### Clause 2

The method of clause 1, further comprising:
determining a baseline voltage based on the performance target;
wherein each of the plurality of voltage candidates is a voltage margin, and the core voltage is selected as the baseline voltage+a maximum of the voltage candidates.

### Clause 3

The method of any of clauses 1 or 2, wherein at least one of the plurality of temperatures is based on a high-temperature sensor positioned at a first location within the processor core and at least one of the plurality of temperatures is based on a low-temperature sensor positioned at a second location within the processor core, wherein a first circuit power density proximate to the first location is higher than a second power density circuitry proximate to the second location.

### Clause 4

The method of any of clauses 1-3, wherein the plurality of locations includes two hot locations determined likely to have a temperature higher than an average temperature of the processor core and one cool location determined likely to have a temperature lower than the average temperature of the processor core.

### Clause 5

The method of any of clauses 1-4, wherein a first temperature of the plurality of temperatures is based on a first sensor positioned proximate to integer processing circuitry, a second temperature of the plurality of temperatures is based on a second sensor positioned proximate to floating point processing circuitry, and a third temperature sensor is based on a third sensor positioned proximate to cache circuitry.

### Clause 6

The method of any of clauses 1-5, further comprising:
determining a memory circuit control parameter based on the plurality of temperatures, the performance target, and the mapping of temperature to voltage margin; and
controlling a memory circuit within the processor core based on the memory circuit control parameter.

### Clause 7

The method of any of clauses 1-6, wherein the estimating of a first temperature of the plurality of temperatures includes adding a first offset to a measurement from a first temperature sensor, wherein the first offset is associated with the location within the processor core corresponding to the first temperature sensor.

### Clause 8

A processor, comprising:
a processor core including a plurality of temperature sensors positioned at a corresponding plurality of locations within the processor core; and
a voltage control engine configured to:
estimate a plurality of temperatures, each temperature based on a corresponding temperature sensor of the plurality of temperature sensors;
determine a plurality of voltage candidates, each voltage candidate based on a corresponding temperature of the plurality of temperatures, a performance target for the processor core, and a mapping of temperature to voltage margin, wherein the mapping includes a direct temperature-to-voltage mapping for a first range of performance targets and an inverse temperature-to-voltage mapping for a second range of performance targets; and
select a core voltage based on a maximum of the voltage candidates; and
a voltage generator supplying the selected core voltage to the processor core.

### Clause 9

The processor of clause 8, wherein the voltage control engine is further configured to:
determine a baseline voltage based on the performance target;
wherein each of the plurality of voltage candidates is a voltage margin, and the core voltage is selected as the baseline voltage+a maximum of the voltage candidates.

### Clause 10

The processor of any of clauses 8 or 9, wherein at least one of the plurality of temperatures is based on a high-temperature sensor positioned at a first location within the processor core and at least one of the plurality of temperatures is based on a low-temperature sensor positioned at a second location within the processor core, wherein a first circuit power density proximate to the first location is higher than a second power density circuitry proximate to the second location.

### Clause 11

The processor of any of clauses 8-10, wherein the plurality of locations includes two hot locations determined likely to have a temperature higher than an average temperature of the processor core and one cool location determined likely to have a temperature lower than the average temperature of the processor core.

### Clause 12

The processor of any of clauses 8-11, wherein a first temperature of the plurality of temperatures is based on a first sensor positioned proximate to integer processing circuitry, a second temperature of the plurality of temperatures is based on a second sensor positioned proximate to floating point processing circuitry, and a third temperature sensor is based on a third sensor positioned proximate to cache circuitry.

### Clause 13

The processor of any of clauses 8-12, wherein the voltage control engine is further configured to:
determine a memory circuit control parameter based on the plurality of temperatures, the performance target, and the mapping of temperature to voltage margin; and
control a memory circuit associated with the processor core based on the memory circuit control parameter.

### Clause 14

The processor of any of clauses 8-13, wherein estimating a first temperature of the plurality of temperatures includes adding a first offset to a measurement from a first temperature sensor, wherein the first offset is associated with the location within the processor core corresponding to the first temperature sensor.

### Clause 15

A system, comprising:
a plurality of processor cores, each core including a plurality of temperature sensors positioned at a corresponding plurality of locations within the processor cores; and
a voltage control engine configured to:
estimate a plurality of temperatures, each temperature based on a corresponding temperature sensor of the plurality of temperature sensors positioned with a first processor core;
determine a plurality of voltage candidates, each voltage candidate based on a corresponding temperature of the plurality of temperatures, a performance target for the first processor core, and a mapping of temperature to voltage margin, wherein the mapping includes a direct temperature-to-voltage mapping for a first range of performance targets and an inverse temperature-to-voltage mapping for a second range of performance targets; and
select a core voltage based on a maximum of the voltage candidates; and
a voltage generator supplying the selected core voltage to the first processor core.

### Clause 16

The system of clause 15, wherein the voltage control engine is further configured to:
determine a baseline voltage based on the performance target;
wherein each of the plurality of voltage candidates is a voltage margin, and the core voltage is selected as the baseline voltage+a maximum of the voltage candidates.

### Clause 17

The system of any of clauses 15 or 16, wherein at least one of the plurality of temperatures is based on a high-temperature sensor positioned at a first location within the first processor core and at least one of the plurality of temperatures is based on a low-temperature sensor positioned at a second location within the first processor core, wherein the first location is proximate to higher-power-density circuitry than the second location.

### Clause 18

The system of any of clauses 15-17, wherein the plurality of locations includes two hot locations determined likely to have a temperature higher than an average temperature of the first processor core and one cool location determined likely to have a temperature lower than the average temperature of the first processor core.

### Clause 19

The system of any of clauses 15-19, wherein a first temperature of the plurality of temperatures is based on a first sensor positioned proximate to integer processing circuitry, a second temperature of the plurality of temperatures is based on a second sensor positioned proximate to floating point processing circuitry, and a third temperature sensor is based on a third sensor positioned proximate to cache circuitry.

### Clause 20

The system of any of clauses 15-20, wherein the mapping of temperature to voltage margin is based on a table, and the selected core voltage is based on an interpolation of two voltages in the table.

In the above detailed description, reference is made to the accompanied drawings, which form a part hereof, and which is shown by way of illustration, specific example configurations of which the concepts can be practiced. These configurations are described in sufficient detail to enable those skilled in the art to practice the techniques disclosed herein, and it is to be understood that other configurations can be utilized, and other changes may be made, without departing from the spirit or scope of the presented concepts. The above detailed description is, therefore, not to be taken in a limiting sense, and the scope of the presented concepts is defined only by the appended claims.

The above description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The phrase “in one example,” as used herein does not necessarily refer to the same embodiment or example, although it may. Use of particular textual numeric designators does not imply the existence of lesser-valued numerical designators. References in the singular are made merely for clarity of reading and include plural references unless plural references are specifically excluded. The term “or” is an inclusive “or” operator unless specifically indicated otherwise. For example, the phrase “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The meaning of “a,” “an,” and “the” includes plural reference, and the meaning of “in” includes “in” and “on.” The term “connected” means a direct electrical connection between the items connected, without any intermediate devices. The term “coupled” means a direct electrical connection between the items connected, or an indirect connection through one or more passive or active intermediary devices and/or components. The term “signal” means at least a power, current, voltage, data, electric wave, magnetic wave, electromagnetic wave, or optical signal. Based upon context, the term “coupled” may refer to a wave or field coupling effect, which may relate to a corresponding optical field, magnetic field, electrical field, or a combined electromagnetic field.

It will be understood that the configurations and/or approaches described herein are examples, and that these specific embodiments or examples are not to be considered in a limiting sense, because numerous variations are possible. As such, various systems, circuits, and/or devices may be broken into additional functions or circuits, and/or combined with other functions or circuits as may be desirable in a specific implementation. Similarly, the specific routines, procedures or methods described herein may represent one or more of any number of processing strategies. As such, various acts illustrated and/or described may be performed in the sequence illustrated and/or described, in other sequences, in parallel, or omitted. Likewise, the order of the above-described processes or methods may be changed. The subject matter thus includes all novel and non-obvious combinations and sub-combinations of the methods, processes, circuits, devices, systems and configurations, and other features, functions and/or properties disclosed herein, as well as any and all equivalents thereof.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for reducing power consumption of a processor core including a plurality of temperature sensors positioned at a corresponding plurality of locations within the processor core, comprising:
estimating a plurality of temperatures, each temperature based on a corresponding temperature sensor of the plurality of temperature sensors;
determining a plurality of voltage candidates, each voltage candidate based on a corresponding temperature of the plurality of temperatures, a performance target for the processor core, and a mapping of temperature to voltage margin, wherein the mapping includes a direct temperature-to-voltage mapping for a first range of performance targets and an inverse temperature-to-voltage mapping for a second range of performance targets;
selecting a core voltage based on a maximum of the voltage candidates; and
controlling a voltage supplied to the processor core based on the selected core voltage.

2. The method of claim 1, further comprising:
determining a baseline voltage based on the performance target;
wherein each of the plurality of voltage candidates is a voltage margin, and the core voltage is selected as the baseline voltage+a maximum of the voltage candidates.

3. The method of claim 1, wherein at least one of the plurality of temperatures is based on a high-temperature sensor positioned at a first location within the processor core and at least one of the plurality of temperatures is based on a low-temperature sensor positioned at a second location within the processor core, wherein a first circuit power density proximate to the first location is higher than a second power density circuitry proximate to the second location.

4. The method of claim 1, wherein the plurality of locations includes two hot locations determined likely to have a temperature higher than an average temperature of the processor core and one cool location determined likely to have a temperature lower than the average temperature of the processor core.

5. The method of claim 1, wherein a first temperature of the plurality of temperatures is based on a first sensor positioned proximate to integer processing circuitry, a second temperature of the plurality of temperatures is based on a second sensor positioned proximate to floating point processing circuitry, and a third temperature sensor is based on a third sensor positioned proximate to cache circuitry.

6. The method of claim 1, further comprising:
determining a memory circuit control parameter based on the plurality of temperatures, the performance target, and the mapping of temperature to voltage margin; and
controlling a memory circuit within the processor core based on the memory circuit control parameter.

7. The method of claim 1, wherein the estimating of a first temperature of the plurality of temperatures includes adding a first offset to a measurement from a first temperature sensor, wherein the first offset is associated with the location within the processor core corresponding to the first temperature sensor.

8. A processor, comprising:
a processor core including a plurality of temperature sensors positioned at a corresponding plurality of locations within the processor core; and
a voltage control engine configured to:
estimate a plurality of temperatures, each temperature based on a corresponding temperature sensor of the plurality of temperature sensors;
determine a plurality of voltage candidates, each voltage candidate based on a corresponding temperature of the plurality of temperatures, a performance target for the processor core, and a mapping of temperature to voltage margin, wherein the mapping includes a direct temperature-to-voltage mapping for a first range of performance targets and an inverse temperature-to-voltage mapping for a second range of performance targets; and
select a core voltage based on a maximum of the voltage candidates; and
a voltage generator supplying the selected core voltage to the processor core.

9. The processor of claim 8, wherein the voltage control engine is further configured to:
determine a baseline voltage based on the performance target;
wherein each of the plurality of voltage candidates is a voltage margin, and the core voltage is selected as the baseline voltage+a maximum of the voltage candidates.

10. The processor of claim 8, wherein at least one of the plurality of temperatures is based on a high-temperature sensor positioned at a first location within the processor core and at least one of the plurality of temperatures is based on a low-temperature sensor positioned at a second location within the processor core, wherein a first circuit power density proximate to the first location is higher than a second power density circuitry proximate to the second location.

11. The processor of claim 8, wherein the plurality of locations includes two hot locations determined likely to have a temperature higher than an average temperature of the processor core and one cool location determined likely to have a temperature lower than the average temperature of the processor core.

12. The processor of claim 8, wherein a first temperature of the plurality of temperatures is based on a first sensor positioned proximate to integer processing circuitry, a second temperature of the plurality of temperatures is based on a second sensor positioned proximate to floating point processing circuitry, and a third temperature sensor is based on a third sensor positioned proximate to cache circuitry.

13. The processor of claim 8, wherein the voltage control engine is further configured to:
determine a memory circuit control parameter based on the plurality of temperatures, the performance target, and the mapping of temperature to voltage margin; and
control a memory circuit associated with the processor core based on the memory circuit control parameter.

14. The processor of claim 8, wherein estimating a first temperature of the plurality of temperatures includes adding a first offset to a measurement from a first temperature sensor, wherein the first offset is associated with the location within the processor core corresponding to the first temperature sensor.

15. A system, comprising:
a plurality of processor cores, each core including a plurality of temperature sensors positioned at a corresponding plurality of locations within the processor cores; and
a voltage control engine configured to:
estimate a plurality of temperatures, each temperature based on a corresponding temperature sensor of the plurality of temperature sensors positioned with a first processor core;
determine a plurality of voltage candidates, each voltage candidate based on a corresponding temperature of the plurality of temperatures, a performance target for the first processor core, and a mapping of temperature to voltage margin, wherein the mapping includes a direct temperature-to-voltage mapping for a first range of performance targets and an inverse temperature-to-voltage mapping for a second range of performance targets; and
select a core voltage based on a maximum of the voltage candidates; and
a voltage generator supplying the selected core voltage to the first processor core.

16. The system of claim 15, wherein the voltage control engine is further configured to:
determine a baseline voltage based on the performance target;
wherein each of the plurality of voltage candidates is a voltage margin, and the core voltage is selected as the baseline voltage+a maximum of the voltage candidates.

17. The system of claim 15, wherein at least one of the plurality of temperatures is based on a high-temperature sensor positioned at a first location within the first processor core and at least one of the plurality of temperatures is based on a low-temperature sensor positioned at a second location within the first processor core, wherein the first location is proximate to higher-power-density circuitry than the second location.

18. The system of claim 15, wherein the plurality of locations includes two hot locations determined likely to have a temperature higher than an average temperature of the first processor core and one cool location determined likely to have a temperature lower than the average temperature of the first processor core.

19. The system of claim 15, wherein a first temperature of the plurality of temperatures is based on a first sensor positioned proximate to integer processing circuitry, a second temperature of the plurality of temperatures is based on a second sensor positioned proximate to floating point processing circuitry, and a third temperature sensor is based on a third sensor positioned proximate to cache circuitry.

20. The system of claim 15, wherein the mapping of temperature to voltage margin is based on a table, and the selected core voltage is based on an interpolation of two voltages in the table.
